(19) United States
(12) Patent Application Publication
(10) Pub. No.: US 2026/0230640 A1
(43) Pub. Date: Aug. 6, 2026

(54) REFRESH INDICATOR FOR CODED VIDEO

(71) Applicant: Telefonaktiebolaget LM Ericsson (publ), Stockholm (SE)

(72) Inventors: Martin PETTERSSON, Vallentuna (SE); Rickard SJÖBERG, Stockholm (SE); Mitra DAMGHANIAN, Upplands-Bro (SE)

(73) Assignee: Telefonaktiebolaget LM Ericsson (publ), Stockholm (SE)

(21) Appl. No.: 19/158,281

(22) PCT Filed: Feb. 16, 2024
(86) PCT No.: PCT/SE2024/050154

§ 371 Date: Aug. 20, 2025

Related U.S. Application Data
(60) Provisional application No. 63/447,959, filed on Feb. 24, 2023.

(51) Int. Cl. H04N 19/44; H04N 19/70

(52) U.S. Cl. CPC H04N 19/44; H04N 19/70

(57) ABSTRACT

A method for decoding a current picture of a video, the current picture comprising a current segment having a recovery picture order count, POC, value. The method includes decoding a refresh indicator value associated with the current picture from a refresh indicator syntax element in a bitstream for the video, the refresh indicator value indicating whether or not the video would be fully refreshed at the current picture when starting the decoding at the current segment. The method also includes determining that the refresh indicator value indicates that the video would not be fully refreshed at the current picture when starting the decoding at the current segment. The method also includes, after determining that the refresh indicator value indicates that the video would not be fully refreshed at the current picture when starting the decoding at the current segment, decoding from a recovery POC value syntax element, which is separate from the refresh indicator syntax element, a value specifying the recovery POC value of the current segment, wherein the recovery POC value indicates a recovery point segment in the bitstream, wherein the recovery point segment is a segment in the bitstream at which the video would be fully refreshed when starting the decoding at the current segment.

### TECHNICAL FIELD

Disclosed are embodiments related to encoding and decoding video.

### BACKGROUND

### Versatile Video Coding (VVC)

Versatile Video Coding (VVC) and its predecessor, High Efficiency Video Coding (HEVC), are block-based video codecs standardized and developed jointly by ITU-T and MPEG. The codecs utilize both temporal and spatial prediction. Spatial prediction is achieved using intra (I) prediction from within a current picture. Temporal prediction is achieved using uni-directional (P) or bi-directional inter (B) prediction on the block level from previously decoded reference pictures.

In the encoder, the difference between the original sample data (a.k.a. pixel data) and the predicted sample data, referred to as the residual, is transformed into the frequency domain, quantized, and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

The VVC version 1 specification was published as Rec. ITU-T H.266|ISO/IEC 23090-3, “Versatile Video Coding,” in 2020. MPEG and ITU-T are working together within the Joint Video Exploratory Team (JVET) on updated versions of HEVC and VVC as well as the successor to VVC, i.e., the next generation video codec.

### Components

A video sequence consists of a series of pictures where each picture consists of one or more components. A picture in a video sequence is sometimes denoted “still image” or “image” or “frame.” Each component in a picture can be described as a two-dimensional rectangular array of sample values (or “samples” for short). It is common that a picture in a video sequence consists of three components: one luma component Y, where the sample values are luma values, and two chroma components Cb and Cr, where the sample values are chroma values. Other common representations include ICtCb, IPT, constant-luminance YCbCr, YCoCg and others. It is also common that the dimensions of the chroma components are smaller than the luma components by a factor of two in each dimension. For example, the size of the luma component of an HD picture would be 1920×1080 and the chroma components would each have the dimension of 960×540. Components are sometimes referred to as ‘color components’, and other times as ‘channels’.

### VVC Block Structure

The VVC video coding standard uses a block structure referred to as quadtree plus binary tree plus ternary tree block structure (QTBT+TT) where each picture is first partitioned into square blocks called coding tree units (CTU). The sizes of all CTUs are identical and the partition is done without any syntax controlling it. Each CTU is further partitioned into coding units (CU) that can have either square or rectangular shapes. The CTU is first partitioned by a quad tree structure, then it may be further partitioned with equally sized partitions either vertically or horizontally in a binary structure to form coding units (CUs). A block could thus have either a square or rectangular shape. The depth of the quad tree and binary tree can be set by the encoder in the bitstream. The ternary tree (TT) part adds the possibility to divide a CU into three partitions instead of two equally sized partitions; this increases the possibilities to use a block structure that better fits the content structure in a picture.

### NAL Units

Both VVC and HEVC define a Network Abstraction Layer (NAL). All the data (i.e., both Video Coding Layer (VCL) or non-VCL data) in HEVC and VVC is encapsulated in NAL units. A VCL NAL unit contains data that represents picture sample values. A non-VCL NAL unit contains additional, associated data, such as parameter sets and supplemental enhancement information (SEI) messages. Each NAL unit in VVC and HEVC begins with a header called the NAL unit header. The syntax for the NAL unit header for HEVC starts with a forbidden_zero_bit that shall always be equal to 0 to prevent start code emulations. Without it, some MPEG systems might confuse the HEVC video bitstream with other data, but the 0 bit in the NAL unit header makes all possible HEVC bitstreams uniquely identifiable as HEVC bitstreams.

The NAL unit header in VVC is very similar to the one in HEVC but uses 1 bit less for the nal_unit_type code word and instead reserves this bit for future use. The nal_unit_type, nuh_layer_id, and nuh_temporal_id_plus1 code words specify the NAL unit type of the NAL unit that identifies what type of data is carried in the NAL unit, the scalability layer ID, and the temporal layer ID for which the NAL unit belongs to, respectively. The NAL unit type indicates and specifies how the NAL unit should be parsed and decoded. The rest of the bytes of the NAL unit is payload of the type indicated by the NAL unit type. A bitstream consists of a series of concatenated NAL units.

A decoder or bitstream parser can determine how a NAL unit should be handled (e.g., parsed and decoded) based on the information in the NAL unit header. The rest of the bytes of the NAL unit is payload of the type indicated by the NAL unit type. All VVC or HEVC bitstreams consist of a series of concatenated NAL units.

Decoding order is the order in which NAL units shall be decoded, which is the same as the order of the NAL units within the bitstream. The decoding order may be different from the output order, which is the order in which decoded pictures are to be output, such as for display, by the decoder.

The NAL unit types of VVC relevant for this disclosure are shown in table 1 below.

TABLE 1

| | Name of | Content of NAL unit and RBSP syntax | NAL unit |
|---|---|---|---|
| nal_unit_type | nal_unit_type | structure | type class |
| . . . | . . . | | . . . |
| 9 | CRA_NUT | Coded slice of a CRA picture or subpicture | VCL |
| | | slice_layer_rbsp( ) | |
| 10 | GDR_NUT | Coded slice of a GDR picture or subpicture | VCL |
| | | slice_layer_rbsp( ) | |
| 11 | RSV_IRAP_11 | Reserved IRAP VCL NAL unit type | VCL |
| . . . | . . . | . . . | . . . |

### Intra Random Access Point (IRAP) Pictures and the Coded Video Sequence (CVS)

For single scalability layer coding in HEVC, an access unit (AU) is the coded representation of a single picture. An AU may consist of several video coding layer (VCL) NAL units as well as non-VCL NAL units.

An intra random access point (IRAP) picture in HEVC is a picture that does not refer to any pictures other than itself for prediction in its decoding process. The first picture in the bitstream in decoding order in HEVC must be an IRAP picture but an IRAP picture may additionally also appear later in the bitstream. HEVC specifies three types of IRAP pictures: 1) the broken link access (BLA) picture, 2) the instantaneous decoder refresh (IDR) picture, and 3) the clean random access (CRA) picture. An IRAP picture may have associated leading pictures, such as random access decodable leading (RADL) pictures and random access skipped leading (RASL) pictures. RADL and RASL are both leading pictures, which are pictures that precede an IRAP picture in output order. RADL pictures are decodable when decoding starts at the associated IRAP picture while RASL pictures are not guaranteed to be decodable when the decoding starts at the IRAP picture and are usually discarded.

A coded video sequence (CVS) in HEVC is a sequence of AUs starting at an IRAP AU followed by zero or more AUs up to, but not including, the next IRAP AU in decoding order.

An IDR picture, when present, starts a CVS. An IDR picture may have associated RADL pictures, but the IDR picture does not have associated RASL pictures.

In HEVC, a BLA picture, when present, starts a CVS and has the same effect on the decoding process as an IDR picture. However, a BLA picture in HEVC may contain syntax elements that specify a non-empty set of reference pictures. A BLA picture may have associated RASL pictures, which are not output by the decoder and may not be decodable, as they may contain references to pictures that may not be present in the bitstream. A BLA picture may also have associated RADL pictures, which are decoded. BLA pictures are not included in VVC.

A CRA picture may have associated RADL or RASL pictures. As with a BLA picture, a CRA picture may contain syntax elements that specify a non-empty set of reference pictures. For CRA pictures, a flag can be set to specify that the associated RASL pictures are not output by the decoder, because they may not be decodable, as they may contain references to pictures that are not present in the bitstream. A CRA may or may not start a CVS.

In VVC, a CVS is a sequence of AUs starting at a CVS start (CVSS) AU followed by zero or more AUs up to, but not including the next CVSS AU in decoding order. A CVSS AU may contain an IRAP picture, i.e., an IDR or a CRA picture, or a gradual decoding refresh (GDR) picture. A CVS may contain one or more coded layer video sequences (CLVSs).

### Gradual Decoding Refresh (GDR)

GDR pictures are essentially used for random access in bitstreams encoded for low-delay coding where an IRAP picture would cause too much delay. A GDR picture may use gradual intra refresh that updates the video picture by picture where each picture is only partially intra coded. A recovery picture order count (POC) value is signaled with the GDR picture and specifies when the video is fully refreshed and ready for output, given that the bitstream was tuned in at the GDR picture. A GDR picture in VVC may start a CVS or CLVS.

That the video is fully refreshed at a current picture or following the recovery point, when starting the decoding at a GDR picture, may be defined as if the POC value (PicOrderCntVal) of the current picture is greater than or equal to the POC value of the recovery point (recoveryPointPocVal) of the associated GDR picture, the current and subsequent decoded pictures in output order are exact match to the corresponding pictures produced by starting the decoding process from the previous IRAP picture, when present, preceding the associated GDR picture in decoding order.

That the video would be fully refreshed at a current picture comprising a current segment when starting the decoding at the current segment may be defined as if the decoding of the video is started at the current segment, then the current picture and pictures that follow the current picture in both decoding order and output order are an exact match to the corresponding pictures produced by starting the decoding process from the IRAP picture preceding the current picture in decoding order. One example of this is when the current picture is an Intra picture and no picture that follows the current picture in both output order and decoding order uses any picture preceding the current picture in decoding order for Inter prediction.

GDR pictures are included as a normative feature in VVC, meaning that it is mandatory a for a VVC decoder to support decoding of bitstreams comprising GDR pictures. GDR is not a normative part of the HEVC standard, where it instead may be indicated with an SEI message (i.e., the recovery point SEI message). In VVC, a GDR picture is indicated with a specific GDR NAL unit type, GDR_NUT, and also indicated in the picture header with the ph_gdr_pic_flag syntax element together with the ph_recovery_poc_cnt syntax element. These syntax elements are further described in the picture header section below.

An issue with the recovery point SEI message in HEVC used for GDR is the fact that it is sent in an SEI message. SEI messages are by nature optional for a decoder to support, meaning that an encoder that wants to provide gradual decoded random access points would not know whether the decoder would be capable of tuning into the stream using the SEI message or not. In practice, the encoder would need to also send periodic IRAP pictures to be sure that the decoder would be able to tune into the stream.

This issue was resolved in VVC by making the GDR mandatory for the decoder to support, that includes signaling the presence of a GDR picture with a GDR specific NAL unit type in the NAL unit header and with the syntax element ph_gdr_pic_flag, followed by the ph_recovery poc_count value further down in the picture header as described above.

A GDR picture in VVC may have a recovery_poc_count value equal to 0, meaning that the GDR picture where the refresh is started is a recovery point picture, where the video has been fully refreshed. The concept of GDR with the recovery POC value equal to 0 is very similar to that of a CRA picture, but has less restrictions, and is in many ways treated the same. For instance, the associated IRAP picture of a DRAP or EDRAP picture may be either an IRAP picture or a GDR picture with recovery POC value equal to 0. DRAP and EDRAP is further described below.

### Slices and Tiles

In HEVC, picture may be divided into independently coded slices, where decoding of one slice in a picture is independent of other slices of the same picture. Different coding types could be used for slices of the same picture. For example, a slice could be an I-slice, P-slice or B-slice. One purpose of slices is to enable resynchronization in case of data loss. In HEVC, a slice is a set of CTUs.

The VVC and HEVC video coding standards include a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### Subpictures

Subpictures are supported in VVC. A subpicture is defined as a rectangular region of one or more slices within a picture. This means a subpicture contains one or more slices that collectively cover a rectangular region of a picture. In the VVC specification, subpicture location and size are signaled in the SPS. Boundaries of a subpicture region may be treated as picture boundaries (excluding in-loop filtering operations) conditioned to a per-subpicture flag (subpic_treated_as_pic_flag[i]) in the SPS. Also loop-filtering on subpicture boundaries is conditioned to a per-subpicture flag loop_filter_across_subpic_enabled_flag[i] in the SPS.

Bitstream extraction and merge operations are supported through subpictures in VVC and could for instance comprise extracting one or more subpictures from a first bitstream, extracting one or more subpictures from a second bitstream and merging the extracted subpictures into a new third bitstream.

### Picture Order Count (POC)

Pictures in HEVC are identified by their POC values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded. The pic_order_cnt_lsb can be signaled by 4-16 bits. There is a variable MaxPicOrderCntLsb used in HEVC which is set to the maximum pic_order_cnt_1sb value plus 1. This means that if 8 bits are used to signal pic_order_cnt_sb, the maximum value is 255 and MaxPicOrderCntLsb is set to 2\hat{ }8=256. The picture order count value of a picture is called PicOrderCntVal in HEVC. Usually, PicOrderCntVal for the current picture is simply called PicOrderCntVal.

### Reference Picture Management

Reference picture management in HEVC is done using reference pictures sets (RPS). The reference picture set is a set of reference pictures that is signaled in the slice headers. When the decoder has decoded a picture, it is put together with its POC value in a decoded picture buffer (DPB). When decoding a subsequence picture, the decoder parses the RPS syntax from the slice header and constructs lists of reference picture POC values.

The reference picture management in the VVC specification differ slightly from the one in HEVC. In HEVC, the RPS is signaled and the reference picture lists to use for Inter prediction is derived from the RPS. In the VVC specification, the reference pictures lists (RPL) are signaled and the RPS is derived. However, in both specifications, signaling of what pictures to keep in the DPB, what pictures should be short-term and long-term is done. Using POC for picture identification and determination of missing reference pictures is done the same in both specifications.

### Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g. data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g. parameter sets) to be provided by external means. “By external means” should be interpreted as the information is not provided in the coded video bitstream but by some other means not specified in the video codec specification, e.g. via metadata possibly provided in a different data channel, as a constant in the decoder, or provided through an API to the decoder.

### Decoding Capability Information (DCI)

In VVC there is a DCI NAL unit. The DCI specifies information that does not change during the decoding session and may be good for the decoder to know about early and upfront, such as profile and level information. The information in the DCI is not necessary for operation of the decoding process. In drafts of the VVC specification the DCI was called decoding parameter set (DPS).

The decoding capability information may also contain a set of general constraints for the bitstream, that gives the decoder information of what to expect from the bitstream, in terms of coding tools, types of NAL units, etc. In VVC, the general constraint information can be signaled in the DCI, VPS or SPS.

### Picture Header

In VVC, a coded picture contains a picture header structure (a.k.a., “picture header” for short). The picture header contains syntax elements that are common for all slices of the associated picture. The picture header may be signaled in its own non-VCL NAL unit with NAL unit type PH_NUT or included in the slice header given that there is only one slice in the coded picture. This is indicated by the slice header syntax element picture_header_in_slice_header_flag, where a value equal to 1 specifies that the picture header is included in the slice header and a value equal to 0 specifies that the picture header is carried in its own PH NAL unit. For a CVS where not all pictures are single-slice pictures, each coded picture must be preceded by a picture header that is signaled in its own NAL unit. HEVC does not support picture headers.

The parts of the syntax and semantics of the picture header relevant to this disclosure are shown below in table 2.

TABLE 2

| | |
|---|---|
| picture_header_structure( ) { | Descript |
| | or |
| ph_gdr_or_irap_pic_flag | u(1) |
| . . . | |
| if( ph_gdr_or_irap_pic_flag ) | |
| ph_gdr_pic_flag | u(1) |
| . . . | |
| ph_pic_parameter_set_id | ue(v) |
| ph_pic_order_cnt_lsb | u(v) |
| if( ph_gdr_pic_flag ) | |
| ph_recovery_poc_cnt | ue(v) |
| . . . | |
| } | |

ph_gdr_or_irap_pic_flag equal to 1 specifies that the current picture is a GDR or IRAP picture. ph_gdr_or_irap_pic_flag equal to 0 specifies that the current picture is not a GDR picture and might or might not be an IRAP picture.

ph_gdr_pic_flag equal to 1 specifies that the current picture is a GDR picture. ph_gdr_pic_flag equal to 0 specifies that the current picture is not a GDR picture. When not present, the value of ph gdr_pic_flag is inferred to be equal to 0. When sps_gdr_enabled_flag is equal to 0, the value of ph_gdr_pic_flag shall be equal to 0. When ph_gdr_or_irap_pic_flag is equal to 1 and ph gdr pic_flag is equal to 0, the current picture is an IRAP picture.

ph_pic_parameter_set_id specifies the value of pps_pic_parameter_set_id for the PPS in use. The value of ph_pic_parameter_set_id shall be in the range of 0 to 63, inclusive. It is a requirement of bitstream conformance that the value of TemporalId of the PH shall be greater than or equal to the value of TemporalId of the PPS that has pps_pic_parameter_set_id equal to ph_pic_parameter_set_id.

ph_pic_order_cnt_Isb specifies the picture order count modulo MaxPicOrderCntLsb for the current picture. The length of the ph_pic_order_cnt_1sb syntax element is sps_log 2_max_pic_order_cnt_lsb_minus4+4 bits. The value of the ph_pic_order_cnt_1sb shall be in the range of 0 to MaxPicOrderCntLsb-1, inclusive.

ph_recovery_poc_cnt specifies the recovery point of decoded pictures in output order.

When the current picture is a GDR picture, the variable recoveryPointPocVal is derived as follows: recoveryPointPocVal=PicOrderCntVal+ph_recovery_poc_cnt.

If the current picture is a GDR picture and ph_recovery_poc_cnt is equal to 0, the current picture itself is also referred to as the recovery point picture. Otherwise, if the current picture is a GDR picture, and there is a picture (picA) that follows the current GDR picture in decoding order in the CLVS that has PicOrderCntVal equal to recoveryPointPocVal, the picture picA is referred to as the recovery point picture, otherwise, the first picture in output order that has PicOrderCntVal greater than recoveryPointPocVal in the CLVS is referred to as the recovery point picture. The recovery point picture shall not precede the current GDR picture in decoding order. The pictures that are associated with the current GDR picture and have PicOrderCntVal less than recovery PointPocVal are referred to as the recovering pictures of the GDR picture. The value of ph_recovery_poc_cnt shall be in the range of 0 to MaxPicOrderCntLsb-1, inclusive.

When sps_gdr_enabled_flag is equal to 1 and PicOrderCntVal of the current picture is greater than or equal to recoveryPointPocVal of the associated GDR picture, the current and subsequent decoded pictures in output order are exact match to the corresponding pictures produced by starting the decoding process from the previous IRAP picture, when present, preceding the associated GDR picture in decoding order.

### SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification. In VVC, an SEI RBSP contains one or more SEI messages.

SEI messages assist in processes related to decoding, display or other purposes. However, SEI messages are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, the decoder discards the message.

ITU-T H.274|ISO/IEC 23002-7, also referred to as VSEI, specifies the syntax and semantics of SEI messages and is particularly intended for use with VVC, although it is written in a manner intended to be sufficiently generic that it may also be used with other types of coded video bitstreams. The first version of ITU-T H.274|ISO/IEC 23002-7 was finalized in July 2020. At the time of writing, version 3 is under development.

### DRAP and EDRAP

Two SEI messages in VSEI are the dependent random access point (DRAP) SEI message and the extended DRAP (EDRAP) SEI message.

The DRAP SEI message is used to indicate a dependent random access point in the bitstream for which the picture only references its associated IRAP picture, i.e. the most recent IRAP picture in decoding order. This allows a decoder to tune into the bitstream at the position of the DRAP picture with the additional requirement that it should first decode the associated IRAP picture. In VVC, the associated IRAP picture of the DRAP picture may also be a GDR picture.

The EDRAP SEI message, as the name suggests, is an extension to the DRAP SEI message, that in addition allows an EDRAP picture to reference any previous DRAP or EDRAP pictures in decoding order following the associated IRAP picture.

### SUMMARY

Certain challenges presently exist. For instance, one problem with the GDR signaling solution in VVC is that the SPS must be parsed to determine whether a picture is a GDR picture with ph_recovery_poc_cnt equal to 0, or not. To be more precise, the ph_recovery_poc_cnt in the picture header is preceded by the ph_pic_order_cnt_1sb, which is encoded with a syntax element where the length of the syntax element is determined by the value of the sps_log 2_max_pic_order_cnt_lsb_minus4 syntax element, which must be decoded from the SPS. Accordingly, a better solution is one in which the value of ph_recovery_poc_cnt, or similar, can be decoded without any dependency to other syntax structures, such as the SPS.

Another problem is that another syntax element before the ph_recovery_poc_cnt syntax element, the ph_pic_parameter_set_id syntax element, is variable-length coded, making it slightly more complex to find the position of the ph_recovery_poc_cnt syntax element such that it can be determined whether the GDR picture has a recovery POC value equal to 0 or not.

Accordingly, in one aspect there is provided a method for decoding a current picture of a video, the current picture comprising a current segment having a recovery picture order count (POC) value. The method includes decoding a refresh indicator value associated with the current picture (e.g., associated with the current segment) from a refresh indicator syntax element in a bitstream for the video, the refresh indicator value indicating whether or not the video would be fully refreshed at the current picture when starting the decoding at the current segment. The method also includes determining that the refresh indicator value indicates that the video would not be fully refreshed at the current picture when starting the decoding at the current segment (i.e., the current picture is not a recovery point picture). The method also includes, after determining that the refresh indicator value indicates that the video would not be fully refreshed at the current picture when starting the decoding at the current segment, decoding from a recovery POC value syntax element, which is separate from the refresh indicator syntax element, a value specifying the recovery POC value of the current segment, wherein the recovery POC value indicates a recovery point segment in the bitstream, wherein the recovery point segment is a segment in the bitstream at which the video would be fully refreshed when starting the decoding at the current segment.

In some aspects, there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of embodiments disclosed herein is that they provide a less complex way to identify whether a GDR picture has a recovery POC value equal to 0 or not. For instance, in one embodiment, it is enough to parse the NAL unit type in the NAL unit header of a NAL unit to determine whether a GDR picture has a recovery POC value equal to 0 or not. In another embodiment it is sufficient to decode an early syntax element in the picture header (or slice header).

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 is a flowchart illustrating a process according to an embodiment.

FIG. 5 is a flowchart illustrating a process according to an embodiment.

FIG. 6 is a flowchart illustrating a process according to an embodiment.

FIG. 7 is a block diagram of an encoding apparatus according to an embodiment.

### DETAILED DESCRIPTION

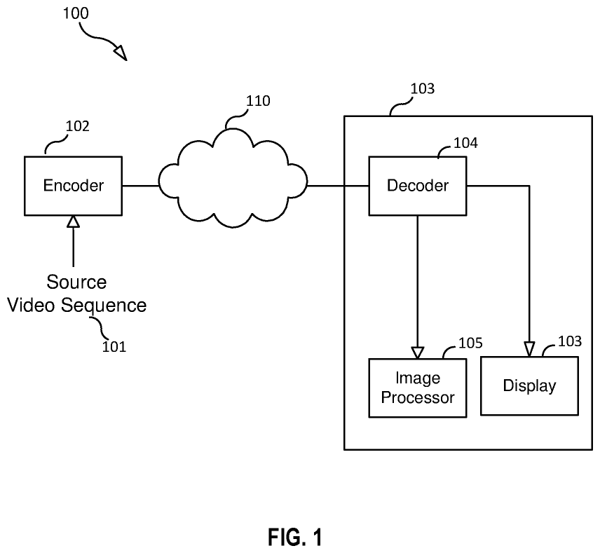

FIG. 1 illustrates a system 100 according to an embodiment. System 100 includes an encoder 102 and a decoder 104, wherein encoder 102 is in communication with decoder 104 via a network 110 (e.g., the Internet or other network). Encoder 102 encodes a source video sequence 101 into a bitstream comprising an encoded video sequence and transmits the bitstream to decoder 104 via network 108. In some embodiments, encoder 102 is not in communication with decoder 104, and, in such an embodiment, rather than transmitting bitstream to decoder 104, the bitstream is stored in a data storage unit for later use. Decoder 104 decodes the pictures included in the encoded video sequence to produce video data for display and/or for further image processing (e.g. a machine vision task). Accordingly, decoder 104 may be part of a device 103 having an image processor 105 and/or a display 106. The image processor 105 may perform machine vision tasks on the decoded pictures. One such machine vision task may be identifying objects in the picture. The device 103 may be a mobile device, a set-top device, a head-mounted display, or any other device.

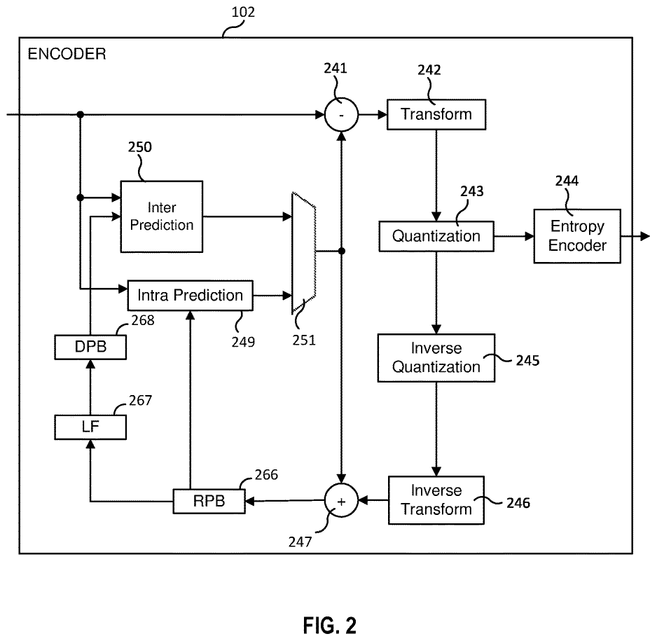

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in sample values between an input block and a prediction block (i.e., the output of a selector 251, which is either an inter prediction block output by an inter predictor 250 (a.k.a., motion compensator) or an intra prediction block output by an intra predictor 249). Then a forward transform 242 is performed on the residual block to produce a transformed block comprising transform coefficients. A quantization unit 243 quantizes the transform coefficients based on a quantization parameter (QP) value (e.g., a QP value obtained based on a picture QP value for the picture in which the input block is a part and a block specific QP offset value for the input block), thereby producing quantized transform coefficients which are then encoded into the bitstream by encoder 244 (e.g., an entropy encoder) and the bitstream with the encoded transform coefficients is output from encoder 102. Next, encoder 102 uses the quantized transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include three sub-stages: i) a deblocking filter, ii) a sample adaptive offset (SAO) filter, and iii) an Adaptive Loop Filter (ALF).

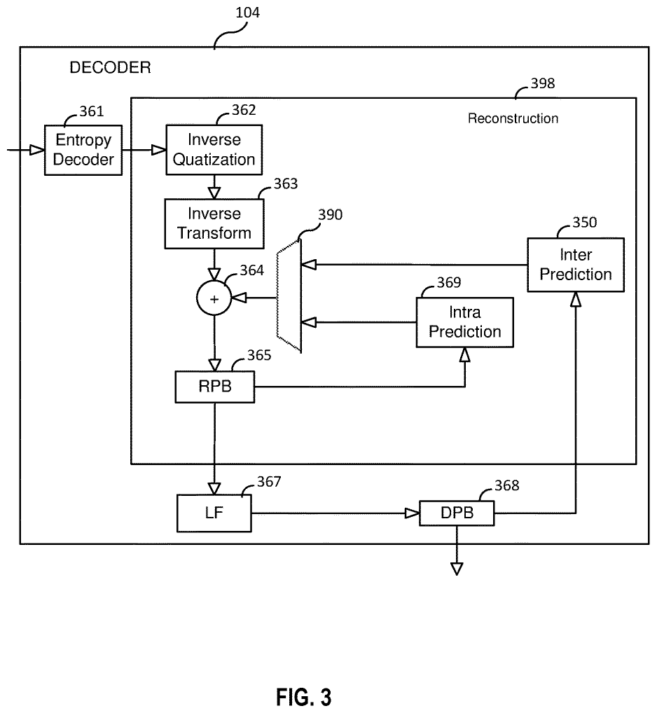

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream quantized transform coefficient values of a block. Decoder 104 also includes a reconstruction stage 398 in which the quantized transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a RPB 365. The inter prediction block is generated by the inter prediction module 350 and the intra prediction block is generated by the intra prediction module 369. Following the reconstruction stage 398, a loop filter stage 367 applies loop filtering and the final decoded picture may be stored in a decoded picture buffer (DPB) 368 and output to image processor 105. Pictures are stored in the DPB for two primary reasons: 1) to wait for picture output and 2) to be used for reference when decoding future pictures.

As described above, a challenge presently exists because the SPS must be parsed to determine whether a picture is a GDR picture with ph_recovery_poc_cnt equal to 0, or not. To overcome this parsing issue, this disclosure proposes a refresh indicator value being signaled in at least a particular syntax element. The refresh indicator value, which is easily accessible, indicates whether or not a current segment (i.e., a picture, a subpicture, a slice, a tile, or other component of a picture) has a recovery POC value (e.g., ph_recovery_poc_cnt) equal to 0. In one embodiment the particular syntax element is signaled in the NAL unit header, more specifically as a new NAL unit type for GDR with recovery POC value equal to 0. In another embodiments, the particular syntax element is signaled in a slice header or picture header. In yet another embodiment, the particular syntax element is signaled in a parameter set or similar syntax structure, such that all GDR pictures in the bitstream may be restricted to have recovery POC value equal to 0 or in another embodiment may be restricted to not have recovery POC value equal to 0.

### The Refresh Indicator Value:

To overcome the parsing issues in VVC for finding out whether a GDR picture has recovery POC value equal to 0 or not, a refresh indicator value is signaled in a “refresh indicator” syntax element in the bitstream. The refresh indicator value indicates whether or not a current segment (e.g., GDR picture) has a recovery POC value equal to 0. The refresh indicator syntax element may consist of a single syntax element or it may comprise two or more syntax elements. Hence, when referring to decoding the refresh indicator value from the refresh indicator syntax element, it is to be understood that the refresh indicator value may be derived from decoding a single syntax element or decoding one or more syntax elements.

The recovery POC value indicates a segment (recovery point segment) in the bitstream where the video has been fully refreshed when starting the decoding at the current segment. The recovery point segment may be a picture, a subpicture, a slice, a tile, or other component of a picture. In one embodiment the POC for the recovery point segment is determined as: POC_{rec_point}=POC_{curr}+recovery POC value, where POC_{rec_point} is the POC of the recovery point segment and POC_{curr} is the POC of the current segment. Accordingly, the recovery POC value is equal to: recovery POC value=POC_{rec_point}−POC_{curr}.

A recovery POC value equal to 0 thus indicates that the video has been fully refreshed after decoding the current segment when starting the decoding at the current segment.

When decoding the refresh indicator value from the refresh indicator syntax element in the bitstream it may be directly determined whether the current segment has a recovery POC value equal to 0 or not. The refresh indicator syntax element is preferably easily accessible, e.g., by the systems layer, early in a header or parameter set. In one embodiment, all syntax elements preceding the refresh indicator syntax element in the header or parameter set are fixed length coded. In another embodiment all syntax elements preceding the refresh indicator syntax element are fixed length coded where the length of each syntax element is given directly or can be determined just from decoding syntax elements from that header or parameter set.

In one embodiment, no NAL unit other than the NAL unit comprising the current segment needs to be parsed in order to determine whether or not the current segment has a recovery POC value equal to 0.

In another embodiment, no other NAL unit than the NAL unit comprising the refresh indicator syntax element needs to be parsed in order to determine whether or not the current segment has a recovery POC value equal to 0.

The refresh indicator syntax element may be a binary flag, or it may be a syntax element representing more than two values. In one embodiment the refresh indicator value indicates either: i) the current segment has a recovery POC value equal to 0 or ii) the current segment has a recovery POC value not equal to 0.

In another embodiment the refresh indicator value indicates: i) the current segment is a GDR segment with a recovery POC value equal to 0, ii) the current segment is a GDR segment with a recovery POC value not equal to 0, or iii) the current segment is not a GDR picture (e.g., another segment type is indicated).

In yet another embodiment the refresh indicator value indicates: i) the current segment is a GDR segment with a recovery POC value equal to 0, ii) the current segment is a GDR segment that may or may not have a recovery POC value equal to 0, or iii) the current segment is not a GDR picture (e.g., another segment type is indicated)

In one embodiment, a decoder may perform all or a subset of the following steps for decoding one or more segments (e.g. picture, sub-picture or slice) from a bitstream.

### Step 1:

Decode a refresh indicator value, associated with a current segment (e.g., picture or slice), from at least a refresh indicator syntax element in the bitstream. The refresh indicator value indicates whether or not the video would be fully refreshed at the current picture comprising the current segment when starting the decoding at the current segment. For example, if the refresh indicator value is equal to a first value (e.g., 1) the refresh indicator value specifies that the video would be fully refreshed at the current picture, and if the refresh indicator value is equal to a second value (e.g. 0) the refresh indicator value specifies that the video may not be fully refreshed at the current picture. The first value may for instance specify that the current segment has a recovery POC value equal to N, whereas the second value may specify that the segment does not have or may not have a recovery POC value equal to N, where N may be equal to 0.

### Step 2:

Determine whether the refresh indicator value is equal to the first value or equal to the second value.

### Step 3:

Determine whether the current segment is a GDR segment. This may be determined from the refresh indicator value. Alternatively, it may be determined from decoding another value from another syntax element (e.g., a NAL unit type syntax element, such as GDR_NUT) in the bitstream.

### Step 4:

Decode the current segment.

Step 5 perform step 5a or step 5b.

### Step 5a:

In response to determining that the refresh indicator value is equal to the first value (e.g. the current segment has a recovery POC value equal to 0): i) infer the recovery POC value to be equal to 0 for the current segment; ii) determine that the video has been fully refreshed when the current segment has been decoded; and iii) output the decoded current segment from the decoder.

### Step 5b:

In response to determining that the refresh indicator value is equal to the second value (e.g. the current segment does not have a recovery POC value equal to 0): i) decode a third value from one or more other syntax elements separate from refresh indicator syntax element, the third value specifying the recovery POC value of the current segment, wherein the recovery POC value indicates a segment in the bitstream at where the video would be fully refreshed when starting the decoding at the current segment; and ii) determine that the video may not have been fully refreshed when the current segment has been decoded.

### Step 6:

In response to determining that the current segment is a GDR segment and the refresh indicator value is equal to the second value (e.g., does not have a recovery POC value equal to 0): i) do not output the current segment; ii) decode all segments in decoding order from the current segment to the segment corresponding to the recovery POC value, e.g. the segment with POC equal to the POC of the current segment plus the recovery POC value, and iii) output the segment corresponding to the recovery POC value.

In one embodiment, an encoder may perform all or a subset of the following steps for encoding a bitstream with one or more segments.

### Step 0:

Determine that a GDR will begin at the current segment. That is, determine that the current segment is a GDR segment.

### Step 1:

Determine a recovery point segment—i.e., the segment in the bitstream where the video will be fully refreshed when starting the decoding at the current segment.

### Step 2:

Determine a recovery POC value for the current segment. This may be calculated as: recovery POC value=POC_{rec_point}−POC_{curr}, where POC_{rec_point} is the POC of the recovery point segment and POC_{curr} is the POC of the current segment.

### Step 3:

Encode a refresh indicator value to a refresh indicator syntax element in the bitstream. The refresh indicator value indicates whether or not the video would be fully refreshed at the current picture comprising the current segment when starting the decoding at the current segment, wherein a refresh indicator value equal to a first value, e.g. 1, specifies that the video would be fully refreshed at the current picture and a refresh indicator value equal to a second value, e.g. 0, specifies that the video may not be fully refreshed at the current picture. The first value may for instance specify that the current segment has a recovery POC value equal to N, whereas the second value may specify that the segment does not have or may not have a recovery POC value equal to N, where N may be equal to 0.

### Step 4:

Encode a GDR indicator to a syntax element in the bitstream, wherein the GDR indicator indicates that the current segment is a GDR segment. This syntax element may or may not be the same syntax element as the refresh indicator syntax element.

### Step 5:

In response to the refresh indicator value being equal to the second value (e.g. the recovery POC value of the current segment is not equal to 0), encode a third value to a recovery POC value syntax element, the third value specifying the recovery POC value of the current segment.

### Step 6:

In response to the refresh indicator value being equal to the first value (e.g., the recovery POC value of the current segment is equal to 0), infer the second value of the recovery POC value syntax element to be equal to 0 (e.g., the encoder sets an internal flag to indicate that the recovery POC value of the current segment is equal to 0).

### Step 7:

Encode the current segment.

### Step 8:

In response to determining that a GDR will begin at the current segment and determining that the refresh indicator value is equal to the second value (e.g., does not have a recovery POC value equal to 0) (i.e., the current segment is a GDR segment but not a recovery point segment), encode all segments in decoding order from the current segment to the recovery point segment. The POC of the recovery point segment may be calculated as POC_{rec_point}=POC_{curr}+recovery POC value.

### Refresh Indicator Signaled in NAL Unit Header

In one embodiment, the refresh indicator syntax element is signaled in the NAL unit header of the current segment. In one embodiment, the refresh indicator syntax element indicates the NAL unit type of the current segment, which indicates whether or not the current segment (e.g., GDR picture) has a recovery POC value equal to 0. That is, in one embodiment, the refresh indicator syntax element is the NAL unit type syntax element (which is named “nal_unit_type”).

In another embodiment, the refresh indicator syntax element is different from the NAL unit type syntax element.

In one embodiment, one value of the NAL unit type specifies that the segment is a GDR segment with recovery POC value equal to 0. This is illustrated in table 3 below. Note that the number for the nal_unit_type, 11, could be any number assigned by the specification.

TABLE 3
NAL unit type codes and NAL unit type classes

| | Name of | Content of NAL unit and RBSP syntax | NAL unit |
|---|---|---|---|
| Nal_unit_type | nal_unit_type | structure | type class |
| . . . | . . . | . . . | . . . |
| 11 | GDR_RPC0_NUT | Coded slice of a GDR picture or subpicture | VCL |
| | | with recovery POC value equal to 0 | |
| | | slice_layer_rbsp( ) | |
| . . . | . . . | . . . | . . . |

In one embodiment, another value of the NAL unit type specifies that the segment is a GDR segment with recovery POC value not equal to 0. This is illustrated in table 4 below.

TABLE 4
NAL unit type codes and NAL unit type classes

| | Name of | Content of NAL unit and RBSP syntax | NAL unit |
|---|---|---|---|
| nal_unit_type | nal_unit_type | structure | type class |
| . . . | . . . | . . . | . . . |
| 10 | GDR_NUT | Coded slice of a GDR picture or | VCL |
| | | subpicture with recovery POC value not | |
| | | equal to 0 | |
| | | slice_layer_rbsp( ) | |
| 11 | GDR_RPC0_NUT | Coded slice of a GDR picture or | VCL |
| | | subpicture with recovery POC value | |
| | | equal to 0 | |
| | | slice_layer_rbsp( ) | |
| . . . | . . . | . . . | . . . |

In another embodiment, another value of the NAL unit type specifies that the segment is a GDR segment without specifying whether the recovery POC value is equal to 0 or not. This is illustrated in table 5 below.

TABLE 5
NAL unit type codes and NAL unit type classes

| | Name of | Content of NAL unit and RBSP syntax | NAL unit |
|---|---|---|---|
| nal_unit_type | nal_unit_type | structure | type class |
| . . . | . . . | . . . | . . . |
| 10 | GDR_NUT | Coded slice of a GDR picture or subpicture | VCL |
| | | slice_layer_rbsp() | |
| 11 | GDR_RPC0_NUT | Coded slice of a GDR picture or subpicture | VCL |
| | | with recovery POC value equal to 0 | |
| | | slice_layer_rbsp( ) | |
| . . . | . . . | . . . | . . . |

In one embodiment, there is one NAL unit type that specifies that the segment is a GDR segment with recovery POC value equal to 0 (GDR_RPCO_NUT) and another NAL unit type that specifies that the segment is a GDR segment with recovery POC value greater than 0 (GDR_NUT).

### Refresh Indicator Signaled in a Segment Header

In one embodiment, the refresh indicator syntax element is signaled in the segment header (e.g., a picture header or a slice header) for the current segment. The refresh indicator syntax element, which may be a single bit encoding either a indicator value or a second indicator value or multiple bits representing multiple values, specifies whether the recovery POC value is equal to 0 or not for the current segment. In one embodiment, the refresh indicator syntax element is only signaled in the case where the current segment is a GDR segment. In another embodiment, the refresh indicator syntax element is always signaled. If the refresh indicator syntax element specifies that the recover POC value for the current segment is not equal to 0, then the recovery POC value for the current segment is signaled using a recovery POC value syntax element. In one embodiment, the signaling of the recovery POC value is also dependent on if the segment is a GDR segment.

The embodiment described immediately above is illustrated with the syntax and semantics below, where the refresh indicator syntax element is named “recovery_poc_cnt_0_flag” and the recovery POC value syntax element is named “recovery_poc_cnt”. In this example, recovery_poc_cnt_0_flag is signaled only if the current segment is a GDR picture, signaled with the gdr flag being equal to 1.

TABLE 6

| | |
|---|---|
| segment_header ( ) { | Descriptor |
| . . . | . . . |
| gdr_flag | u(1) |
| if (gdr_flag) | |
| recovery_poc_cnt_0_flag | u(1) |
| . . . | |
| if( gdr_flag && !recovery_poc_cnt_0_flag ) | |
| recovery_poc_cnt | ue(v) |
| . . . | |
| } | |

gdr_flag equal to 1 specifies that the picture of the current segment is a GDR picture (i.e., the current segment is a GDR picture or the current segment is a part (e.g., slice, tile, subpicture) of a GDR picture). gdr_flag equal to 0 specifies that the picture of the current segment is not a GDR picture. When not present, the value of gdr_flag is inferred to be equal to 0.

recovery_poc_cnt_0_flag equal to 1 specifies that the recovery POC value of the current segment is equal to 0. Recovery_poc_cnt_0_flag equal to 0 indicates that the recovery POC value of the current segment is not equal to 0.

recovery_poc_cnt specifies the recovery point of decoded pictures in output order.

When the picture of the current segment is a GDR picture, the variable recoveryPointPocVal is derived as follows: recoveryPointPocVal=PicOrderCntVal+recovery_poc_cnt.

If the picture of the current segment is a GDR picture and recovery_poc_cnt is equal to 0, the GDR picture itself is also referred to as the recovery point picture. If the picture of the current segment is a GDR picture (denoted current GDR picture) and there is a picture picA that follows the current GDR picture in decoding order in the sequence that has PicOrderCntVal equal to recoveryPointPocVal, then picture picA is referred to as the recovery point picture, otherwise, the first picture in output order that has PicOrderCntVal greater than recoveryPointPocVal in the sequence is referred to as the recovery point picture. The recovery point picture shall not precede the current GDR picture in decoding order. The pictures that are associated with the current GDR picture and have PicOrderCntVal less than recoveryPointPocVal are referred to as the recovering pictures of the current GDR picture. The value of recovery_poc_cnt shall be in the range of 0 to MaxPicOrderCntLsb-1, inclusive. When not present, the value of recovery_poc_cnt is inferred to be equal to 0.

In this example, the signaled recovery_poc_cnt is allowed to be 0. In another embodiment the signaled recovery_poc_cnt is not allowed to be 0, e.g. it may be restricted to be in the range of 1 to MaxPicOrderCntLsb-1. Another variant would be to have the recovery POC value syntax element be denoted as “recovery_poc_cnt_minus1” for which the recovery POC value syntax element specifies the recovery POC value of the current segment minus 1 and for which recoveryPointPocVal is derived as: recoveryPointPocVal=PicOrderCntVal+recovery_poc_cnt_minus1+1, when the recovery_poc_cnt_0_flag is equal to 0. When the recovery_poc_cnt_0_flag is equal to 1, the recoveryPointPocVal is derived as: recoveryPointPocVal=PicOrderCntVal.

In another embodiment, the refresh indicator syntax element and the recovery POC value syntax element are signaled in different headers or parameter sets. For instance, the refresh indicator syntax element may be signaled in the SPS or PPS and the recovery POC value syntax element in the picture header, or the refresh indicator syntax element may be signaled in the SPS or PPS and the recovery POC value syntax element in the slice header or the refresh indicator syntax element may be signaled in the picture header and the recovery POC value syntax element in the slice header.

### Refresh Indicator Signaled in Parameter Set (or Similar)

In a fourth embodiment, the refresh indicator syntax element is signaled in a parameter set or a similar syntax structure such as the DCI of VVC.

In this embodiment, the refresh indicator syntax element specifies or indicates whether all or none of the GDR pictures in the scope of the parameter set (or similar syntax structure), has a recovery POC value of 0. The scope of the parameter set or similar syntax structure is the set of pictures for which the parameter set or similar syntax structure is valid, e.g. an SPS is valid for a sequence, a PPS is valid for the pictures of a sequence which reference that PPS, a VPS is valid for pictures of multiple layers, and a DCI is valid for the whole decoding session.

In one embodiment the refresh indicator syntax element specifies or indicates whether all of the GDR pictures in the scope of the parameter set or similar syntax structure comprises a recovery POC value of 0, or some of the GDR pictures in the scope of the parameter set or similar syntax structure may comprise a recovery POC value different from 0. This embodiment is illustrated with the syntax and semantics shown in table 7 below. Here the refresh indicator syntax element is signaled in a general constraint info structure which in VVC is signaled in either a DCI, a VPS, or an SPS. A first value of the refresh indicator syntax element restricts all GDR pictures to have a recovery POC value equal to 0. This forbids a GDR over several pictures, but allows for the special case of GDR with recovery POC value 0.

TABLE 7

| | |
|---|---|
| general_constraints_info( ) { | Descriptor |
| . . . | |
| all_recovery_poc_cnt_0_flag | u(1) |
| . . . | |
| } | |

all_recovery_poc_cnt_0_flag equal to 1 specifies that the value of recovery_poc_cnt for every GDR picture in the bitstream shall be equal to 0. all_recovery_poc_cnt_0_flag equal to 0 does not impose such a constraint.

A similar example is given in the syntax and semantics below as signaled in a parameter set.

TABLE 8

| | |
|---|---|
| parameter_set_rbsp( ) { | Descriptor |
| . . . | |
| all_recovery_poc_cnt_0_flag | u(1) |
| . . . | |
| } | |

all_recovery_poc_cnt_0_flag equal to 1 specifies that the value of recovery_poc_cnt for every GDR picture in the scope of the parameter set shall be equal to 0. all_recovery_poc_cnt_0_flag equal to 0 specifies that the value of recovery_poc_cnt for any GDR picture in the scope of the parameter set may or may not be equal to 0.

In another embodiment, the first value of the syntax element restricts all GDR pictures to have a recovery POC value different from 0. This forbids the special case of GDR with recovery POC value 0, but allows for a GDR over several pictures. This is illustrated with the example syntax and semantics below.

TABLE 9

| | |
|---|---|
| general_constraints_info( ) { | Descriptor |
| . . . | |
| no_recovery_poc_cnt_0_flag | u(1) |
| . . . | |
| } | |

no_recovery_poc_cnt_0_flag equal to 1 specifies that the value of recovery_poc_cnt for every GDR picture in the bitstream shall not be equal to 0. all_recovery_poc_cnt_0_flag equal to 0 does not impose such a constraint.

A similar example is given in the syntax and semantics below as signaled in a parameter set.

TABLE 10

| | |
|---|---|
| parameter_set_rbsp( ) { | Descriptor |
| . . . | |
| no_recovery_poc_cnt_0_flag | u(1) |
| . . . | |
| } | |

no_recovery_poc_cnt_0_flag equal to 1 specifies that the value of recovery_poc_cnt for every GDR picture in the scope of the parameter set shall not be equal to 0. no_recovery_poc_cnt_0_flag equal to 0 specifies that the value of recovery_poc_cnt for any GDR picture in the scope of the parameter set may or may not be equal to 0.

In one embodiment, a bitstream rewriter receives a bitstream with GDR pictures with recovery POC value equal to 0, sets the no_recovery_poc_cnt_0_flag equal to 1 (forbidding GDR with recovery POC value 0), and replaces all GDR pictures with recovery POC value 0 in the scope, e.g., in the bitstream or the scope of a parameter set, with CRA pictures or pictures of similar nature.

In one embodiment, a first refresh indicator value is signaled at a first hierarchy level, e.g., the SPS or GCI, indicating whether or not GDR segments with recovery POC value equal to 0 are allowed for that hierarchy level, e.g., in the CVS or bitstream, and a second refresh indicator value is signaled at a second hierarchy level, e.g. in the PPS or PH, indicating whether or not GDR segments with recovery POC value equal to 0 are allowed or used for that hierarchy level, e.g. the picture(s) referring to the PPS or PH, and the value for the second indicator overrides the value for the first indicator. E.g., the first indicator may indicate that GDR segments with recovery POC value equal to 0 are allowed, while the second indicator may indicate that GDR segments with recovery POC value equal to 0 are not allowed.

Having two CRA types, with and without rule for RADL and RASL

In one embodiment, a new random access type is introduced (hereafter denoted “Intra type B”). The new type is to be used in addition to an existing random access type (hereafter denoted “Intra type A”) such as, for example, the CRA random access type known from HEVC and VVC. This CRA type has the rule that specifies that any leading picture to a picture of CRA type must be either a picture of type RADL or a picture of type RASL. Intra Type B, defined here, does not have this rule, which means that a leading picture to a picture of Intra Type B can be a picture of the same type as a trailing picture to the picture of Intra Type B, for example type TRAIL.

According to this embodiment, a decoder may perform all or a subset of the following steps for decoding a first picture, a second picture, and a third picture from a bitstream, where the second picture follows the first picture in decoding order, the third picture follows the second picture in decoding order, the first picture follows the second picture in output order, and the third picture follows the first picture in output order.

### Step 1:

Decode a first picture type value from a picture type syntax element in the bitstream, where the first picture type value specifies a picture type of the first picture.

### Step 2:

Decode a second picture type value from a second syntax element in the bitstream, where the second picture type value specifies a picture type of the second picture.

### Step 3:

Decode a third picture type value from a third syntax element in the bitstream, where the third picture type value specifies a picture type of the third picture.

The first picture type value specifies either that i) the first picture is an Intra type A picture or ii) the first picture is an Intra type B picture. Both first picture type values Intra type A and Intra type B indicates that a random access operation on the bitstream is provided at the first picture, such that if a random access operation is performed at the first picture, correctly decoded sample values can be decoded for the first picture and any picture that follows the first picture in both decoding order and output order.

In one embodiment, the following two rules apply:
(1) If the first picture type value specifies an Intra type A, then the second picture type value is not allowed to be equal to the third picture type value; and
(2) If the first picture type value specifies an Intra type B, then the second picture type value is allowed to be equal to the third picture type value.

In one embodiment, when the first picture type value specifies an Intra type B, the second picture type value and the third picture type value must be the same value, for example a value that specifies the TRAIL picture type.

In one embodiment, when the first picture type value specifies an Intra type A, the second picture type value is a value that specifies that the second picture is a leading picture. For example, the second picture type may specify one of a RADL or RASL picture type. Also, when the first picture type value specifies an Intra type A, the third picture type value is a value that specifies that the third picture is a trailing picture.

In one embodiment the third picture type is a TRAIL type and Intra type A is a CRA type.

In one embodiment, the first picture type value specifies that the first picture is an Intra type B picture (e.g., the first picture type value is set equal to GDR_RPCO_NUT), the second picture type value specifies that the second picture is a TRAIL picture, and the third picture type value specifies that the third picture is a TRAIL picture.

In one embodiment the first, second and third syntax elements are decoded from NAL unit headers associated with the first, second and third picture, respectively. In one embodiment, a bitstream may comprise an Intra type A picture and an Intra type B picture, where each of these two Intra pictures has one leading picture and one trailing picture. Here the leading picture of the Intra type A picture must be signalled as a different type than the trailing picture of the Intra type A picture, while the leading picture of the Intra type B picture may be signalled as the same type as the trailing picture of the Intra type B picture.

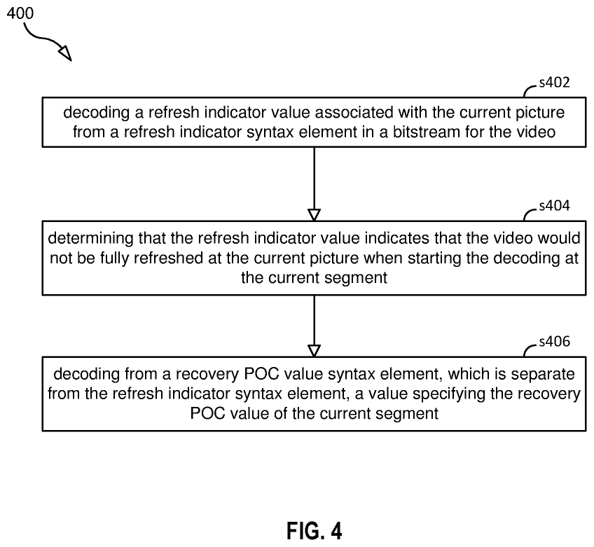

FIG. 4 is a flowchart illustrating a process 400 for decoding a current picture of a video, the current picture comprising a current segment having a recovery picture order count (POC) value. Process 400 may begin in step s402. Step s402 comprises decoding a refresh indicator value associated with the current picture (e.g., associated with the current segment) from a refresh indicator syntax element in a bitstream for the video, the refresh indicator value indicating whether or not the video would be fully refreshed at the current picture when starting the decoding at the current segment. Step s404 comprises determining that the refresh indicator value indicates that the video would not be fully refreshed at the current picture when starting the decoding at the current segment (i.e., the current picture is not a recovery point picture). Step s406 comprises, after determining that the refresh indicator value indicates that the video would not be fully refreshed at the current picture when starting the decoding at the current segment, decoding from a recovery POC value syntax element, which is separate from the refresh indicator syntax element, a value specifying the recovery POC value of the current segment, wherein the recovery POC value indicates a recovery point segment in the bitstream, wherein the recovery point segment is a segment in the bitstream at which the video would be fully refreshed when starting the decoding at the current segment.

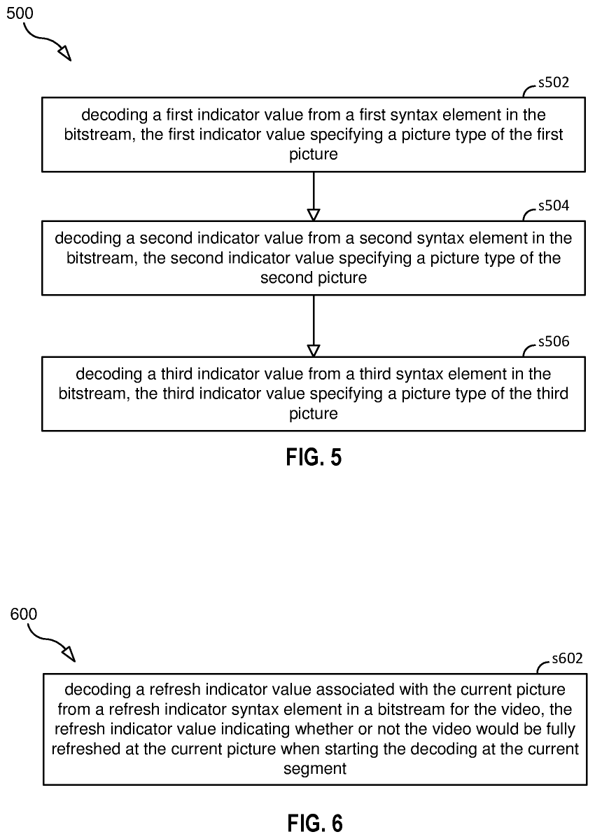

FIG. 5 is a flowchart illustrating a process 500 for decoding a first picture (e.g., a random access picture), a second picture (e.g., a leading picture—i.e., decoded after random access picture but displayed before the random access picture), and a third picture (e.g., a trailing picture—i.e., a picture decoded and displayed after the first picture) from a video bitstream. Process 500 may begin in step s502.

Step s502 comprises decoding a first indicator value from a first syntax element in the bitstream, the first indicator value specifying a picture type of the first picture, wherein the specified picture type of the first picture is either a first picture type (e.g., Intra type A) or a second picture type (e.g., Intra type B).

Step s504 comprises decoding a second indicator value from a second syntax element in the bitstream, the second indicator value specifying a picture type of the second picture.

Step s506 comprises decoding a third indicator value from a third syntax element in the bitstream, the third indicator value specifying a picture type of the third picture.

The second picture follows the first picture in decoding order, the third picture follows the second picture in decoding order, the first picture follows the second picture in output order, the third picture follows the first picture in output order, if the first picture is specified as being of the first picture type (e.g. type A), then the second indicator value is not allowed to be equal to the third indicator value, if the first picture is specified as being of the second picture type (e.g. type B), then the second indicator value is allowed to be equal to the third indicator value, and if a random access operation is performed at the first picture, then correctly decoded sample values can be decoded for the first picture and one or more pictures that follow the first picture in both decoding order and output order.

FIG. 6 is a flowchart illustrating a process 600 for decoding a current picture of a video, the current picture comprising a current segment. Process 600 may begin in step s602. Step s602 comprises decoding (s602) a refresh indicator value associated with the current picture (e.g., associated with the current segment) from a refresh indicator syntax element in a bitstream for the video, the refresh indicator value indicating whether or not the video would be fully refreshed at the current picture when starting the decoding at the current segment, wherein i) a NAL unit contains the refresh indicator value syntax element and every syntax element contained in said NAL unit and preceding the refresh indicator syntax element in said NAL unit is a fixed length coded syntax element, ii) a NAL unit contains the refresh indicator value syntax element and every syntax element contained in said NAL unit and preceding the refresh indicator syntax element in said NAL unit can be parsed without dependency on any other NAL unit, iii) the refresh indicator syntax element is signaled in a NAL unit header, iv) the refresh indicator syntax element is a NAL unit type syntax element, or v) the refresh indicator syntax element is signaled in at least one parameter set or a similar syntax structure, e.g., one of a DCI, VPS, SPS, PPS or a GCI syntax structure.

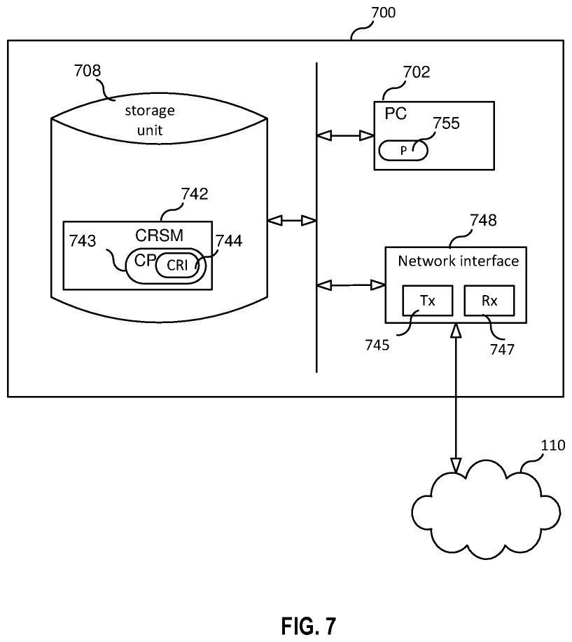

FIG. 7 is a block diagram of an apparatus 700 for implementing encoder 102 and/or decoder 104, according to some embodiments. When apparatus 700 implements encoder 102, apparatus 700 may be referred to as an encoder apparatus, and when apparatus 700 implements decoder 104, apparatus 700 may be referred to as a decoder apparatus. As shown in FIG. 7, apparatus 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., encoder apparatus 700 may be a distributed computing apparatus); at least one network interface 748 (e.g., a physical interface or air interface) comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling encoder apparatus 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes encoder apparatus 700 to perform steps described herein (e.g., steps described herein with reference to the flow charts). In other embodiments, encoder apparatus 700 may be configured to perform steps described herein without the need for code. That is, for example, PC 702 may consist merely of one or more ASICs. Hence, the features of the embodiments described herein may be implemented in hardware and/or software.

### Summary of Various Embodiments

A1. A method (400) for decoding a current picture of a video, the current picture comprising a current segment having a recovery picture order count (POC) value, the method comprising:
decoding (s402) a refresh indicator value associated with the current picture (e.g., associated with the current segment) from a refresh indicator syntax element in a bitstream for the video, the refresh indicator value indicating whether or not the video would be fully refreshed at the current picture when starting the decoding at the current segment;
determining (s404) that the refresh indicator value indicates that the video would not be fully refreshed at the current picture when starting the decoding at the current segment (i.e., the current picture is not a recovery point picture); and after determining that the refresh indicator value indicates that the video would not be fully refreshed at the current picture when starting the decoding at the current segment, decoding (s406) from a recovery POC value syntax element, which is separate from the refresh indicator syntax element, a value specifying the recovery POC value of the current segment, wherein the recovery POC value indicates a recovery point segment in the bitstream, wherein the recovery point segment is a segment in the bitstream at which the video would be fully refreshed when starting the decoding at the current segment.

A2. The method according to embodiment A1, wherein
the decoded refresh indicator value is either equal to a first value or a second value,
if the refresh indicator value is equal to the first value, then the refresh indicator value specifies that the current segment has a recovery POC value equal to N, and
if the refresh indicator value is equal to the second value, then the refresh indicator value specifies that the current segment has a recovery POC value that is not equal to N.

A3. The method according to embodiment A2, wherein N is equal to 0.

A4. The method of any of embodiment A2 to A3, wherein the method further comprises, in response to determining that the refresh indicator value is equal to the first value, inferring the recovery POC value to be equal to N for the current segment or the current picture.

A5. The method of any of the previous embodiments, wherein the refresh indicator value further indicates that the current segment is a gradual decoding refresh, GDR, segment

A6. The method of any of embodiments A1-A5, further comprising:
determining that the video may not have been fully refreshed when the current segment has been decoded,
decoding the current segment,
not outputting the current segment,
decoding all segments in decoding order from the current segment to the segment corresponding to the recovery POC value, and/or
outputting the segment corresponding to the recovery POC value.

A7. The method of any one of embodiments A1-A6, wherein the recovery point segment is:
a segment in the bitstream with a POC value equal to the POC value of the current segment plus the recovery POC value, or
a segment in the bitstream with a POC value equal to the POC value of the current segment plus the recovery POC value or the segment with the lowest POC value that is greater than the sum of the POC value of the current segment and the recovery POC value.

A8. The method of any of the previous embodiments, wherein the refresh indicator syntax element is a one bit flag.

A9. The method of any of the previous embodiments, wherein the current segment is at least one of a picture, a subpicture, a slice, or a tile.

A10. The method of any of the previous embodiments, wherein the recovery point segment is at least one of a picture, a subpicture, a slice, or a tile.

A11. The method of any of the previous embodiments, wherein the recovery POC value is an integer value greater than 0.

A12. The method of any of the previous embodiments, wherein no NAL unit other than the NAL unit comprising the current segment needs to be parsed in order to decode the refresh indicator value from the refresh indicator value syntax element.

A13. The method of any of the previous embodiments, wherein
a NAL unit contains the refresh indicator value syntax element, and
every syntax element contained in said NAL unit and preceding the refresh indicator syntax element in said NAL unit is a fixed length coded syntax element.

A14. The method of any of the previous embodiments, wherein
a NAL unit contains the refresh indicator value syntax element, and
every syntax element contained in said NAL unit and preceding the refresh indicator syntax element in said NAL unit can be parsed without dependency on any other NAL unit.

A15. The method of any of the previous embodiments, wherein the refresh indicator syntax element is signaled in a NAL unit header.

A16. The method of any of the previous embodiments, wherein
the refresh indicator syntax element is a NAL unit type syntax element, and
an indicator value equal to a first value indicates that the current segment is a GDR segment with a recovery POC value equal to 0 NAL unit type.

A17. The method of any of the embodiments A1-15, wherein
the refresh indicator syntax element is a NAL unit type syntax element, and
an indicator value equal to a second value indicates that the current segment is a GDR segment with recovery POC value not equal to 0, e.g. greater than 0.

A18. The method of any of embodiments A1-A17, wherein the refresh indicator syntax element is signaled in at least one of a picture header or a slice header.

A19. The method of any of embodiments A1-18, wherein the refresh indicator syntax element is signaled in at least one parameter set or a similar syntax structure, e.g., one of a DCI, VPS, SPS, PPS or a GCI syntax structure.

A20. The method of embodiment A19 wherein
if the refresh indicator value has a first value, all GDR segments referring to the at least one parameter set or similar syntax structure have a recovery POC value equal to 0,
else if the refresh indicator value has a second value, all GDR segments referring to the at least one parameter set or similar syntax structure does not have, or may not have, a recovery POC value equal to 0.

A21. The method of embodiment A19 wherein
if the refresh indicator value has a second value, all GDR segments referring to the at least one parameter set or similar syntax structure do not have a recovery POC value equal to 0,
else if the refresh indicator value has a first value, all GDR segments referring to the at least one parameter set or similar syntax structure do have, or may have, a recovery POC value equal to 0.

A22. The method of any of the previous embodiments, wherein the refresh indicator syntax element and the recovery POC value syntax element are signaled in the same header or parameter set.

A23. The method of any of embodiments A1-A21, wherein the refresh indicator syntax element and the recovery POC value syntax element are signaled in different headers or parameter sets.

A24. The method of any one of embodiments A1-A23, wherein the current picture consists of the current segment.

B1. A method (500) for decoding a first picture (e.g., a random access picture), a second picture (e.g., a leading picture—i.e., decoded after random access picture but displayed before the random access picture), and a third picture (e.g., a trailing picture—i.e., a picture decoded and displayed after the first picture) from a video bitstream, the method comprising:
decoding (s502) a first indicator value from a first syntax element in the bitstream, the first indicator value specifying a picture type of the first picture, wherein the specified picture type of the first picture is either a first picture type (e.g., Intra type A) or a second picture type (e.g., Intra type B)
decoding (s504) a second indicator value from a second syntax element in the bitstream, the second indicator value specifying a picture type of the second picture; and
decoding (s506) a third indicator value from a third syntax element in the bitstream, the third indicator value specifying a picture type of the third picture, wherein
the second picture follows the first picture in decoding order,
the third picture follows the second picture in decoding order,
the first picture follows the second picture in output order,
the third picture follows the first picture in output order,
if the first picture is specified as being of the first picture type (e.g. type A), then the second indicator value is not allowed to be equal to the third indicator value,
if the first picture is specified as being of the second picture type (e.g. type B), then the second indicator value is allowed to be equal to the third indicator value, and
if a random access operation is performed at the first picture, then correctly decoded sample values can be decoded for the first picture and one or more pictures that follow the first picture in both decoding order and output order.

B2. The method of embodiment B1, wherein
the first indicator value specifies that the first picture is of the second picture type, and
the second indicator value is equal to the third indicator value.

B3. The method of any embodiment B1 or B2 wherein the second picture uses, for prediction, a reference picture that precedes the first picture in both decoding order and output order.

B4. The method of any one of embodiment B1-B3, further comprising:
decoding a fourth indicator value from a fourth syntax element in the bitstream, the fourth indicator value specifying a picture type of a fourth picture included in the bitstream, wherein the specified picture type of the fourth picture is equal to the first picture type (e.g., Intra type A);
decoding a fifth indicator value from a fifth syntax element in the bitstream, the fifth indicator value specifying a picture type of a fifth picture included in the bitstream; and
decoding a sixth indicator value from a sixth syntax element in the bitstream, the sixth indicator value specifying a picture type of a sixth picture included in the bitstream, wherein
the fifth picture follows the fourth picture in decoding order,
the sixth picture follows the fifth picture in decoding order,
the fourth picture follows the fifth picture in output order,
the sixth picture follows the fourth picture in output order.

B5. The method of embodiment B4, wherein
the sixth indicator value specifies that the sixth picture is a trailing picture (i.e., the sixth picture should be decoded after the first picture and output after the first picture), and
the fourth indicator value specifies that the fourth picture is a CRA picture, and
the fifth indicator value specifies that the fifth picture is a leading picture.

B6. The method of embodiment B4 or B5, wherein the first, second, third, fourth, fifth and sixth syntax elements are decoded from NAL unit headers associated with the first, second, third, fourth, fifth, and sixth picture, respectively.

B7. The method of any one of embodiments B1-B6, wherein
the bitstream comprises a first coded video sequence, CVS, and a second CVS, and
the first, second, and third pictures are included in the first CVS.

B8. The method of embodiment B6 when dependent on embodiment B4, B5, or B6, wherein the fourth, fifth, and sixth pictures are included in the second CVS.

C1. A method (600) for decoding a current picture of a video, the current picture comprising a current segment, the method comprising:
decoding (s602) a refresh indicator value associated with the current picture (e.g., associated with the current segment) from a refresh indicator syntax element in a bitstream for the video, the refresh indicator value indicating whether or not the video would be fully refreshed at the current picture when starting the decoding at the current segment, wherein
i) a NAL unit contains the refresh indicator value syntax element and every syntax element contained in said NAL unit and preceding the refresh indicator syntax element in said NAL unit is a fixed length coded syntax element,
ii) a NAL unit contains the refresh indicator value syntax element and every syntax element contained in said NAL unit and preceding the refresh indicator syntax element in said NAL unit can be parsed without dependency on any other NAL unit,
iii) the refresh indicator syntax element is signaled in a NAL unit header,
iv) the refresh indicator syntax element is a NAL unit type syntax element, or
v) the refresh indicator syntax element is signaled in at least one parameter set or a similar syntax structure, e.g., one of a DCI, VPS, SPS, PPS or a GCI syntax structure.

D1. A computer program (743) comprising instructions (744) which when executed by processing circuitry (702) of an apparatus (700) causes the apparatus to perform the method of any one of the above embodiments.

D2. A carrier containing the computer program of embodiment C1, wherein the carrier is one of an electronic signal, an optical signal, a radio signal, and a computer readable storage medium (742).

D3. A decoder apparatus (700) configured to perform the method of any one of the previous embodiments.

While the terminology in this disclosure is described in terms of VVC, the embodiments of this disclosure also apply to any existing or future codec, which may use a different, but equivalent terminology.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for decoding a current picture of a video, the current picture comprising a current segment having a recovery picture order count, (POC) value, the method comprising:
decoding a refresh indicator value associated with the current picture from a refresh indicator syntax element in a bitstream for the video, the refresh indicator value indicating whether or not the video would be fully refreshed at the current picture when starting the decoding at the current segment;
determining that the refresh indicator value indicates that the video would not be fully refreshed at the current picture when starting the decoding at the current segment; and
after determining that the refresh indicator value indicates that the video would not be fully refreshed at the current picture when starting the decoding at the current segment, decoding from a recovery POC value syntax element, which is separate from the refresh indicator syntax element, a value specifying the recovery POC value of the current segment, wherein
the recovery POC value indicates a recovery point segment in the bitstream, and
the recovery point segment is a segment in the bitstream at which the video would be fully refreshed when starting the decoding at the current segment.

2. The method of claim 1, wherein
the decoded refresh indicator value is either equal to a first value or a second value,
if the refresh indicator value is equal to the first value, then the refresh indicator value specifies that the current segment has a recovery POC value equal to N, and
if the refresh indicator value is equal to the second value, then the refresh indicator value specifies that the current segment has a recovery POC value that is not equal to N.

3. The method of claim 2, wherein N is equal to 0.

4. The method of claim 2, wherein the method further comprises, in response to determining that the refresh indicator value is equal to the first value, inferring the recovery POC value to be equal to N for the current segment or the current picture.

5. The method of claim 1, wherein the refresh indicator value further indicates that the current segment is a gradual decoding refresh; (GSR) segment.

6. The method of claim 1, further comprising:
determining that the video may not have been fully refreshed when the current segment has been decoded,
decoding the current segment,
not outputting the current segment,
decoding all segments in decoding order from the current segment to the segment corresponding to the recovery POC value, and/or
outputting the segment corresponding to the recovery POC value.

7. The method of claim 1, wherein the recovery point segment is:
a segment in the bitstream with a POC value equal to the POC value of the current segment plus the recovery POC value, or
a segment in the bitstream with a POC value equal to the POC value of the current segment plus the recovery POC value or the segment with the lowest POC value that is greater than the sum of the POC value of the current segment and the recovery POC value.

8. The method of claim 1, wherein the refresh indicator syntax element is a one bit flag.

9. The method of claim 1, wherein the current segment is at least one of a picture, a subpicture, a slice, or a tile.

10. The method of claim 1, wherein the recovery point segment is at least one of a picture, a subpicture, a slice, or a tile.

11-19. (canceled)

20. The method of claim 1, wherein
if the refresh indicator value has a first value, all gradual decoding refresh (GSR) segments referring to the at least one parameter set or similar syntax structure have a recovery POC value equal to 0,
else if the refresh indicator value has a second value, all GDR segments referring to the at least one parameter set or similar syntax structure does not have, or may not have, a recovery POC value equal to 0.

21. The method of claim 1, wherein
if the refresh indicator value has a second value, all gradual decoding refresh (GSR) segments referring to the at least one parameter set or similar syntax structure do not have a recovery POC value equal to 0,
else if the refresh indicator value has a first value, all GDR segments referring to the at least one parameter set or similar syntax structure do have, or may have, a recovery POC value equal to 0.

22. The method of claim 1, wherein the refresh indicator syntax element and the recovery POC value syntax element are signaled in the same header or parameter set.

23. The method of claim 1, wherein the refresh indicator syntax element and the recovery POC value syntax element are signaled in different headers or parameter sets.

24. The method of claim 1, wherein the current picture consists of the current segment.

25. A non-transitory computer readable storing medium storing a computer program comprising instructions which when executed by processing circuitry of an apparatus causes the apparatus to perform the method of claim 1.

26. (canceled)

27. A decoder apparatus the decoder apparatus comprising:
memory; and
processing circuitry, wherein the decoder apparatus is configured to perform a method for decoding a current picture of a video, the current picture comprising a current segment having a recovery picture order count value, the method comprising:
decoding a refresh indicator value associated with the current picture from a refresh indicator syntax element in a bitstream for the video, the refresh indicator value indicating whether or not the video would be fully refreshed at the current picture when starting the decoding at the current segment;
determining that the refresh indicator value indicates that the video would not be fully refreshed at the current picture when starting the decoding at the current segment; and
after determining that the refresh indicator value indicates that the video would not be fully refreshed at the current picture when starting the decoding at the current segment, decoding from a recovery POC value syntax element, which is separate from the refresh indicator syntax element, a value specifying the recovery POC value of the current segment, wherein
the recovery POC value indicates a recovery point segment in the bitstream, and
the recovery point segment is a segment in the bitstream at which the video would be fully refreshed when starting the decoding at the current segment.
